(19) United States
(12) Patent Application Publication
(10) Pub. No.: US 2024/0313227 A1
(43) Pub. Date: Sep. 19, 2024

(54) RECHARGEABLE SILICON-CARBON ANODE LITHIUM BATTERIES WITH AN IMPROVED LOW TEMPERATURE DISCHARGE CAPACITY

(71) Applicant: TDA Research, Inc., Wheat Ridge, CO (US)

(72) Inventors: Brian J Elliott, Superior, CO (US); Vinh T. Nguyen, Arvada, CO (US); Rhia M. Martin, Arvada, CO (US); Joseph Reinicke, Lakewood, CO (US)

(21) Appl. No.: 18/649,070

(22) Filed: Apr. 29, 2024

Related U.S. Application Data
(63) Continuation-in-part of application No. 18/531,673, filed on Dec. 6, 2023.
(60) Provisional application No. 63/437,841, filed on Jan. 9, 2023.
(60) Provisional application No. 63/441,091, filed on Jan. 25, 2023.

(51) Int. Cl. H01M 4/62; H01M 4/02; H01M 4/38; H01M 4/525; H01M 4/583; H01M 10/052; H01M 10/0569

(52) U.S. Cl. CPC H01M 4/623; H01M 4/386; H01M 4/525; H01M 4/583; H01M 4/625; H01M 10/052; H01M 10/0569; H01M 2004/027; H01M 2004/028

(57) ABSTRACT

A battery with a Si/C anode, a separator; a nickel metal oxide cathode, a lithium salt, a first solvent, having a low melting point, a second solvent having a high electrochemical stability, The battery has a charge transfer-assisting polymer coating that coats a liquid electrolyte-solid cathode interfacial surface of the nickel metal-oxide cathode. Alternatively, the battery has a charge transfer-assisting polymer coating that coats that coats a liquid electrolyte-solid cathode interfacial surface of the Si/C anode. The battery has enhanced discharge specific energy at −40 to −60° C.

### CROSS REFERENCE TO RELATED APPLICATIONS

The present application is a continuation-in-parts application and claims the benefit of the non-provisional application Ser. No. 18/531,673 filed Dec. 6, 2023 (titled Rechargeable Batteries with Improved Low Temperature Performance, by Brian J. Elliott, Vinh T. Nguyen, Rhia M Martin, and Joseph Reinicke, attorney docket number 23-1)C, which is incorporated by reference herein. The present application also claims the benefit of provisional application No. 63/437,841 filed Jan. 9, 2023 (titled Rechargeable Batteries with Improved Low Temperature Discharge Capacity, by Brian J. Elliott, Vinh T. Nguyen, Rhia M Martin, and Joseph Reinicke, attorney docket number 23-1), which is incorporated by reference herein. The present application also claims the benefit of the provisional application No. 63/441,091 filed Jan. 25, 2023 (titled Rechargeable Batteries with Improved Low Temperature Discharge Capacity, by Brian J. Elliott, Vinh T. Nguyen, Rhia M Martin, and Joseph Reinicke, attorney docket number 23-1B), which is incorporated by reference herein.

### STATEMENT OF GOVERNMENT INTEREST

This invention was made in part using U.S. government funding through the NASA SBIR Phase I Contract No 80NSSC22PB215. The government has certain rights in the invention.

### FIELD OF THE INVENTION

The present disclosure relates generally to rechargeable lithium batteries that have enhanced low temperature discharging performance and that have a silicon-carbon anode and contain either a cathode or an anode with a coating made from a charge transfer-enhancing polymer coating material.

### BACKGROUND OF THE INVENTION

There is a need for high energy density rechargeable batteries with improved low-temperature discharge performance. Future science missions to the lunar surface will require hardware, electronics and energy storage systems that can tolerate the extreme low temperatures of the lunar night. Some missions will require continuous operation through the night and others will only need to tolerate it and wake up and operate at the lunar dawn. Other mission near the poles may only receive marginal heating from the sun due to shadows and low sun angles. The temperatures expected (about −180° Cat night, lower in craters, and up to 30 120° C. in the day) dictate that batteries and electronics currently must be housed in temperature regulated chambers kept between 0° C. and +40° C., because this is where lithium-ion cells have adequate performance.

Automotive electronics are rated down to −40° C. and military electronics are rated down to −55° C. and it would be advantageous to have rechargeable batteries that could work well at the same low temperature ranges (either down to −40° C. or −55° C.) to match the limits of existing electronics.

There are similar low temperature requirements for electric or hybrid electric aircraft, stratospheric balloons or drones, and arctic exploration instruments on Earth. Thus, there are also terrestrial transportation and science applications of batteries that have better extreme low temperature discharge capacity and specific energy.

### SUMMARY OF THE INVENTION

The present disclosure teaches a solution to the poor low-temperature discharge performance of high energy lithium rechargeable batteries with a silicon-carbon anode. The disclosure provides a battery with a silicon and carbon composite anode; a separator; a nickel metal oxide cathode; a lithium salt; a first solvent, having a low melting point, which is either methyl propionate or butyl propionate; and a second solvent having a high electrochemical stability, which is either fluoroethylene carbonate or ethylene carbonate; and, wherein the first solvent and the second solvent are present at a volume ratio of (first solvent:second solvent) from (1.0:0.01) to (1.0:0.3). The nickel metal oxide cathode comprises an active material either NMC811, NMC622, NMC532 a mixed metal nickel-oxide with at least 50 weight % nickel, at least 5 weight % manganese and at least 5 weight % cobalt, or an aluminum-doped mixed metal nickel-oxide with at least 50 weight % nickel and at least 5 weight % aluminum. The cathode may have an electrically conductive carbon and a binder, preferably polyvinylidene fluoride. The battery has a charge transfer-assisting polymer coating that coats the liquid electrolyte-solid cathode interfacial surface of the nickel metal-oxide cathode. Alternatively, the battery has a charge transfer-assisting polymer coating that coats the liquid electrolyte-solid cathode interfacial surface of the silicon-carbon anode. Lastly, the battery may have the coating on both the cathode and the anode, and the low-temperature discharge is enhanced by the coating(s).

### BRIEF DESCRIPTION OF THE FIGURES

FIG. 1: Chemical structures of the monomers used to make the charge transfer-assisting polymer coatings.

FIG. 2: Chemical structures of imidazolium monomers used to make the charge transfer-assisting polymer coatings.

FIG. 3: Chemical structures of ammonium monomers used to make the charge transfer-assisting polymer coatings.

FIG. 4: Examples of imidazolium monomers with PF₆_{^{−}} anions.

FIG. 5: Examples of imidazolium monomers with Br-anions.

FIG. 6: Illustration of the “carbon in the 2-position of the imidazolium ring” and examples of a methyl substitution at the 2-position.

FIG. 7: Chemical structure of the monomer used to form the SEI and CEI in the examples shown in FIG. 8, 10-12.

FIG. 8: Discharge specific energy for an 18650 battery cell with and without the added charge transfer-assisting polymer coating, as a function of temperature.

FIG. 9: Electro impedance spectroscopy (EIS) ideal circuit and illustrating how to measure the electrolyte resistance, the CEI resistance and the charge transfer resistance.

FIG. 10: Electrolyte resistance in a NMC811 battery with and without the charge transfer-assisting polymer coating, as a function of temperature.

FIG. 11: Cathode electrolyte interphase (CEI) resistance in NMC811 battery with and without the charge transfer-assisting polymer coating, as a function of temperature.

FIG. 12: Charge transfer resistance in a NMC811 battery with and without the charge transfer-assisting polymer coating, as a function of temperature.

FIG. 13: Nyquist plots from EIS tests on cells with and without the charge transfer-assisting polymer coating.

FIG. 14: Illustration of the full single layer (coin cell) battery cell with the artificial SEI and CEI.

FIG. 15: Table of specific energy discharge at various temperatures.

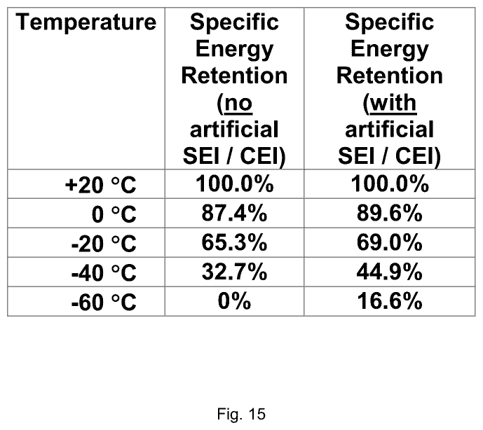

FIG. 16: Charge/discharge capacity for Si/C | NMC811 coin cells with 9:1 MP:FEC electrolyte (with LiPF6). Comparing coulombic efficiency with and without the artificial CEI.

### DETAILED DESCRIPTION OF THE INVENTION

The low temperature performance of lithium batteries, in general, is limited by several factors: (1) the conductivity of the electrolyte; (2) the resistance of the solid electrolyte interface (SEI) or the cathode electrolyte interface (CEI); and (3) the charge transfer resistance of the SEI and/or CEI (moving lithium ions into and out of the solid electrodes).

Fluorinated carbonate liquid electrolytes are capable of cycling down to −60° C., however improvements in capacity retention at extreme low temperatures ( −40° C. to −60° C.) are still needed for operating electronics in the lunar day-night cycle, or for stratospheric balloons and drones operating in the Earth day-night cycle.

Solid-liquid interfaces in lithium batteries can suffer from slow lithium ion transfer across this boundary, especially when cold. The present disclosure teaches a specific ionically conductive additive that is used to form an artificial solid electrolyte interphase (SEI), and/or an artificial cathode electrolyte interphase (CEI) in situ during cell formation, or ex situ directly on the electrode surfaces prior to cell assembly. The artificial SEI, CEI or both promote lithium diffusion between electrodes and the electrolyte (and prevent unwanted side chemical reactions between the liquid electrolyte and the solid electrodes: anode or cathode). The disclosure also teaches a specific electrolyte blend(s) that when combined with the polymer coating on the electrodes allows enhanced battery discharge at low temperatures (i.e. at or below −40° C.). Other ionically conductive polymers in the prior art typically cannot perform well in very wide temperature ranges: such as those expected on the lunar surface. The existing polymer materials used for artificial SEI's/CEI's either melt or dissolve when too hot or they become non-conductive when too cold. Other artificial SEls and CEIs lack the synergy with the disclosed electrolyte formulations that operate in combination with the artificial SEI or CEI disclosed herein. Advancements that address battery operation at extreme temperatures, combined with high specific energy are still critically needed, and are tough by this disclosure.

The present disclosure solves this problem by teaching an artificial SEI/CEI that solves the poor lithium conductivity at the solid-liquid interphases in high energy density batteries at −40°° C. to −60° C. The polymer used as the artificial CEI or SEI of the disclosure is stable at both high (over 100° C.) and low (lower than −80° C.) temperatures. The same artificial SEI/CEI even provides some discharge capacity at −80° C. when combined with the low temperature electrolyte formulations. The present disclosure teaches the production, chemistry and components of a battery that can pair with electronics rated to −55° C., for example. The polymer artificial SEI/CEI does not melt or degrade at high temperatures (100° C.) and a battery containing it retains 44.9% of the room temperature specific energy of the battery when discharged at −40° C. (and still maintain 24.5% of the specific energy at −55° C.). It is difficult to maintain both the capacity (the total current) and the available voltage (power) at low temperatures. The artificial CEI taught herein increases the discharge voltage, and thus also increases the discharge energy.

This disclosure provides an artificial SEI for Si/C and an artificial CEI for high-nickel cathodes, such as NMC811, and others. Although not required, the ion conducting polymer may be made from the monomers that are annealed prior to polymerization so that it possesses 3-deminstonally interconnected nanopores, a result of a self-assembly process. Although not wishing to be bound by theory, the self-assembly process may result in an enhanced ionic conductivity at low temperatures. This is because the polymer forms a rigid nanoporous polymer that doesn't melt and that doesn't rely on polymer segmental motions for lithium ion transport at low temperature. Rather, the ions may transport through the nanopores in a “hopping” mechanism.

Although not wishing to be bound by theory, the polymer (either self-assembled or not self-assembled) provides a domain with a high concentration of anionic species to shield the lithium ion from the liquid electrolyte solvation sphere, which is strongly binding to the lithium ion. In doing so, the polymer coating may provide a reduced charge transfer resistance by accelerating the insertion of the lithium ion into the anode or the cathode (on either charge for the silicon-carbon anode, and on discharge for the cathode).

The term “silicon-carbon anode” or “Si/C anode” means a silicon and carbon composite anode where the silicon is present a at least 2 wt %, preferably at least 5 wt %, and more preferably about 20 wt %. A Si/C composite electrode may contain 20% silicon and 65% graphite by weight. The balance may be made up of binders, and other carbon additives. A 20% silicon anode may have a capacity of about 750 mAh/g at 0.05C or an electrode loading of about 4 mAh/cm².

The term “separator” means an electrically insulating battery separator membrane use to electronically isolate the anode from the cathode, while allowing liquid solvent and/or lithium ion to pass through during charging and discharging of the battery. The separator may be a porous polymer membrane, may be a polypropylene membrane, a polyethylene membrane, another polymer membrane, a glass fiber membrane, a non-woven borosilicate glass fiber membrane with or without binders. The separator may be 1 to 40 microns thick, preferably 10 to 20 microns thick. The separator preferably has at least 50% porosity and a low lithium ion diffusion resistance.

The term “nickel metal oxide cathode” means a cathode comprising at least 60% nickel metal oxide, optionally binders, optionally conductivity enhancers such a carbon black, and a current collector such as aluminum. The nickel metal oxide may be either NMC811, NMC622, NMC532 a mixed metal nickel-oxide with at least 50 weight % nickel, at least 5 weight % manganese and at least 5 weight % cobalt, or an aluminum-doped mixed metal nickel-oxide with at least 50 weight % nickel and at least 5 weight % aluminum.

The term “lithium salt” means a battery-grade lithium salt such as Li PF₆⁻, Li Tf₂N⁻, Li BF₄ and Li FSI⁻

The term “low melting point” means a melting point lower than −20 to −40° C., preferably lower than −60° C.

The term “high electrochemical stability” means the compound forms a protective SEI or CEI in a lithium battery, with a lithium ion conductivity of at least 1×10⁻⁴S/cm at 20° C. and which does not readily desorb or decompose on the electrode during cycling from 2 to 4.2 volts.

The term “charge transfer-assisting polymer coating” means a polymer coating that when applied to either an anode or a cathode lowers the charge transfer resistance (for at least one temperature where the charge transfer is measured) during charging or discharging (in a lithium battery).

The term “liquid electrolyte-solid cathode interfacial surface of the nickel metal-oxide cathode” means the interface between the cathode and the liquid electrolyte where with the native CEI or the artificial CEI exists in a full lithium battery.

The term “latent polymerizable diene monomer” means a monomer the contains a polymerizable diene functional group that can be polymerized at a controlled time by either applying heat or light.

The term “spacer group” is a chemical group that is covalently bonded to both the cationic headgroup and the latent polymerizable diene group.

The term “cationic headgroup” mean a cationic function group at an end of the monomer.

The term “Tf₂N” means bis(trifluoromethylsulfonyl)imide.

The term “FSI ” means bis(fluorosulfonyl)imide.

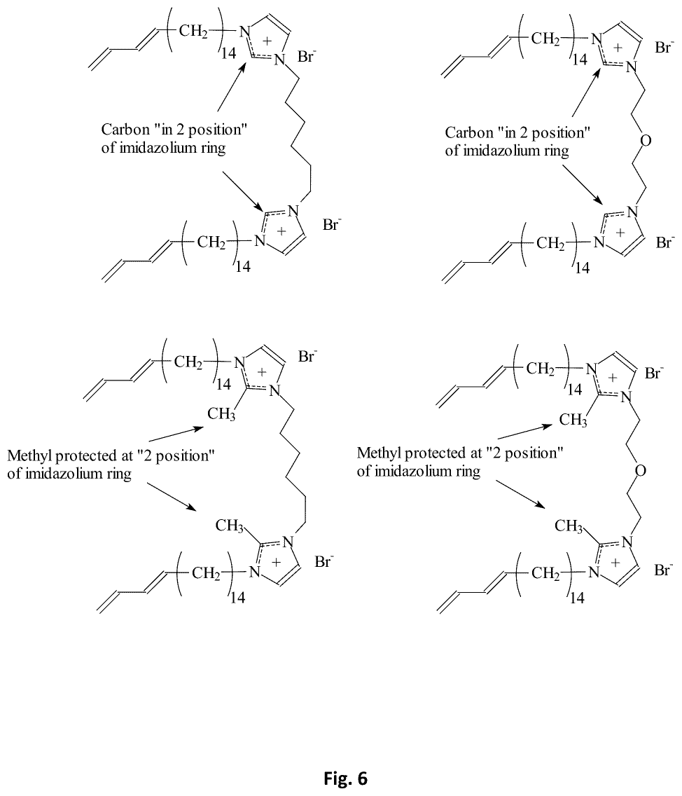

The term “position 2 of the imidazolium functional group” means the standard definition in the chemical sciences as illustrated in FIG. 6.

The term “liquid electrolyte-solid anode interfacial surface of the Si/C anode” means the interface between the cathode and the liquid electrolyte where with the native CEI or the artificial CEI exists in a full lithium battery.

The artificial SEI/CEI is illustrated in FIG. 17. An artificial CEI is applied to the cathode (and alternatively an SEI also on the anode). A low temperature liquid electrolyte and a conventional separator (not illustrated in FIG. 17) are used in combination with these artificial interfaces. The result is a significantly improved discharge capacity at −40° C. and −60° C. compared to the same battery cell with no artificial SEI or CEI.

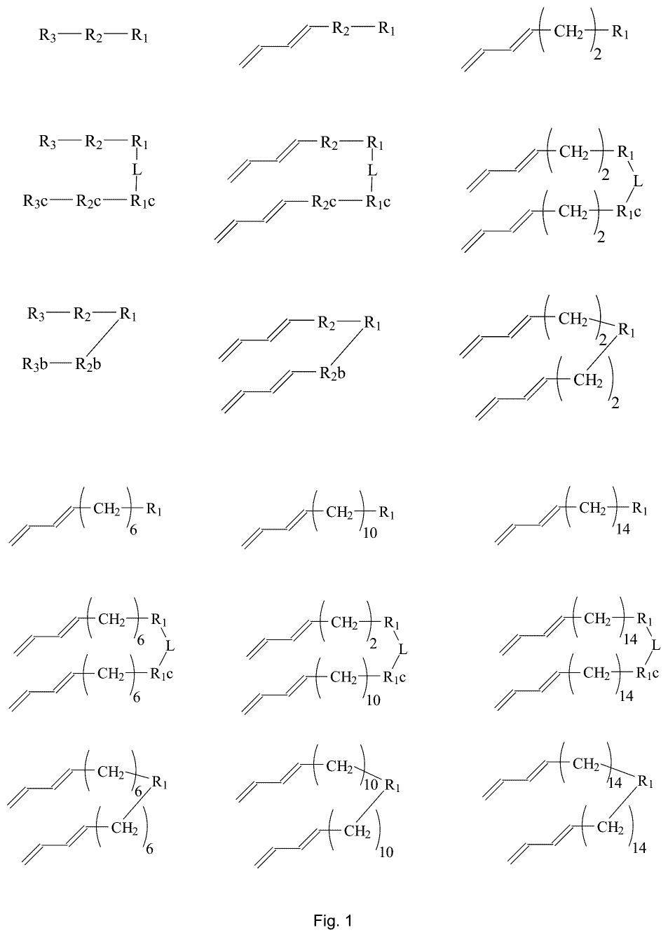

FIG. 1 shows examples of the chemical structures used as precursors to make the polymer coatings. The monomers contain a cationic headgroup (R₁), a spacer group (R₂) and a latent polymerizable diene (R₃). In some variations there is one cationic headgroup, and in others there are two cationic headgroups. Versions with two cationic headgroups (R₁) and (R_{1b}) or (R₁) and (R_{1c}) also have a linker group (L). The linker group may be (CH2)x, where x=2, 3, 4, 5, 6, 7, or 8, or C—C—O—C—C.

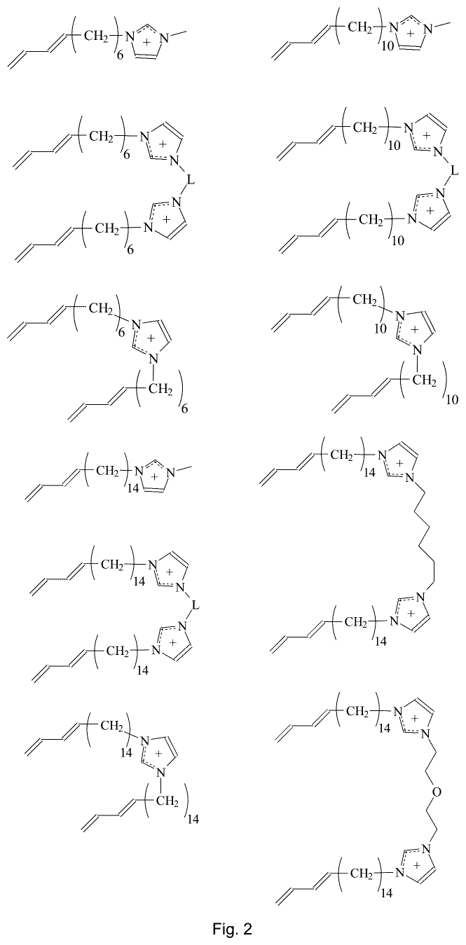

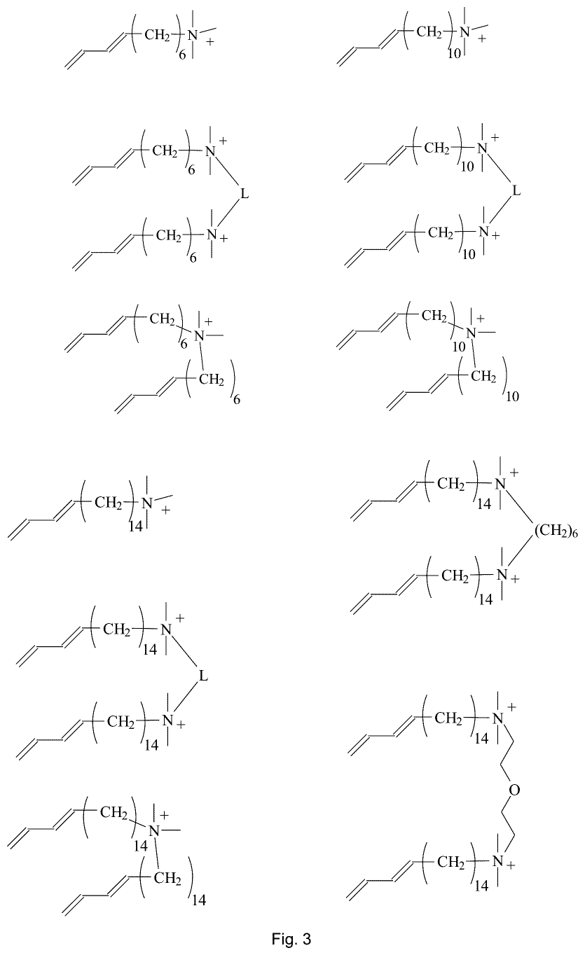

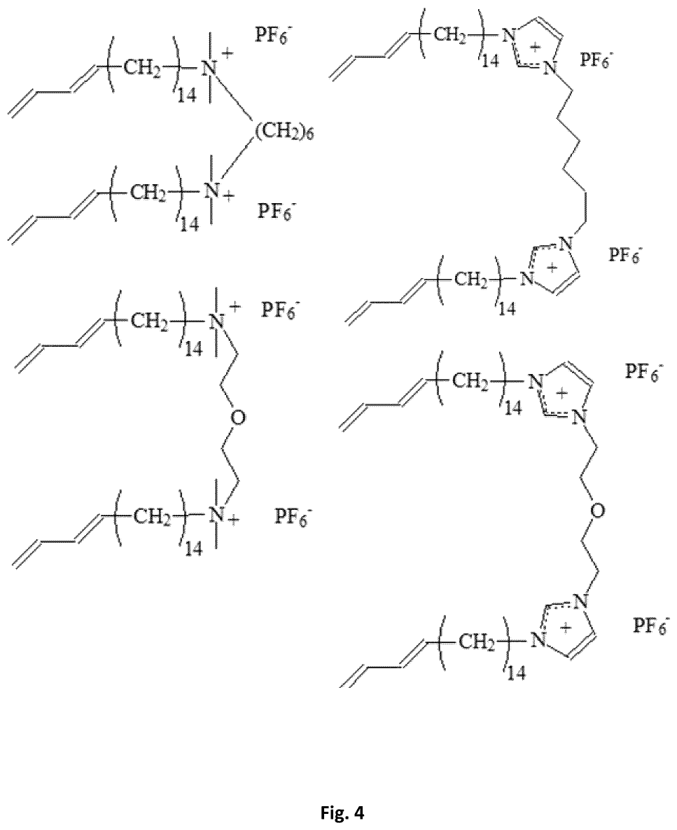

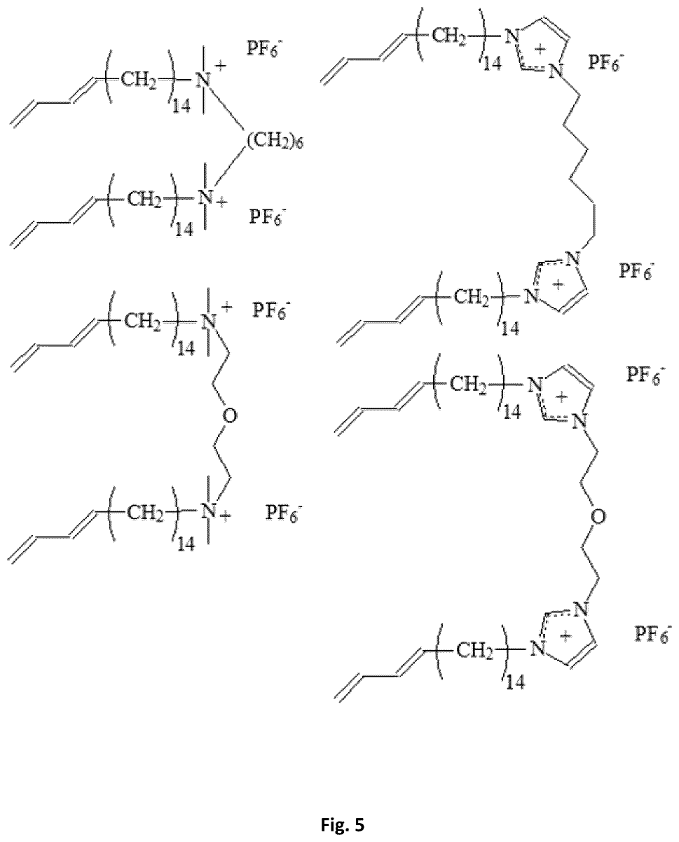

FIGS. 2 through 5 show other imidazolium and ammonium versions of the monomers that can form the charge transfer-assisting polymer coating.

The charge transfer-assisting polymer coating may be applied to a high nickel cathode where the polymer coating has a thickness of from 0.1 to 10 microns, preferably 0.1 to 3 microns, more preferably 0.2 to 0.5 microns and most preferably about 0.3 microns.

The charge transfer-assisting polymer coating may be applied to a Si/C anode, where the polymer coating has a thickness of from 0.1 to 10 microns, preferably 0.1 to 3microns, more preferably 0.3 to 1.0 microns and even more preferably either 0.3 microns or 1.0 microns.

The monomers may be spray applied with an ultrasonic spray applicator from a solution in a solvent. Preferably anhydrous methanol, where the monomer is 1 to 5% by mass in the methanol sprayable solution. A radical photopolymerization initiator, or a radical thermal polymerization initiator may be added at 0.1 to 3 weight %. The methanol may be evaporated off, leaving the monomer and polymerization initiator. The coated electrode may be exposed to ultraviolet light to cure the coating in place. The monomers may be heated (to 45 to 70° C.) to anneal and induce a self-assembly process prior to photopolymerization. Alternatively, a thermal polymerization can be used to cure the coating. Additional self-assembly directing additives may be added, for example glycerol, and 5 to 30 weight % based on the mass of the monomer. Preferably 15 to 20 weight % glycerol.

The monomer may alternatively be mixed with the liquid electrolyte and added to a full battery cell prior to cell sealing. The sealed battery may be cycled a few times (charged/discharged) during the normal “formation” process. The monomers will sacrificially polymerize (via electropolymerization) on the surfaces of the anode and/or cathode. The monomer is preferably added to the liquid electrolyte at 0.5 to 10 weight %, alternatively 1 to 5 weight %.

FIG. 6 shows the chemical structure of monomers of this disclosure that have the “2 position” protected by a methyl protecting group. Although not wishing to be bound by theory, adding a protecting group (either methyl, ethyl or propyl) at the 2-position produces a more electrochemically stable polymer because the hydrogen atom in the 2-position of the normal imidazolium is prone to abstraction in harsh conditions or at high voltages.

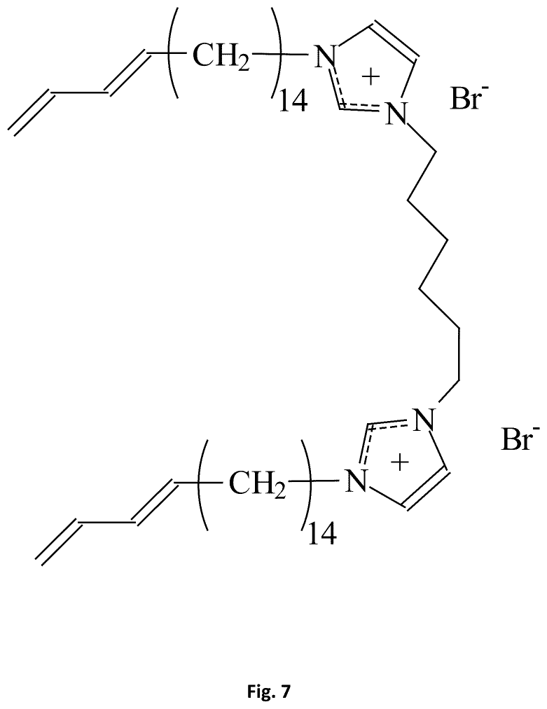

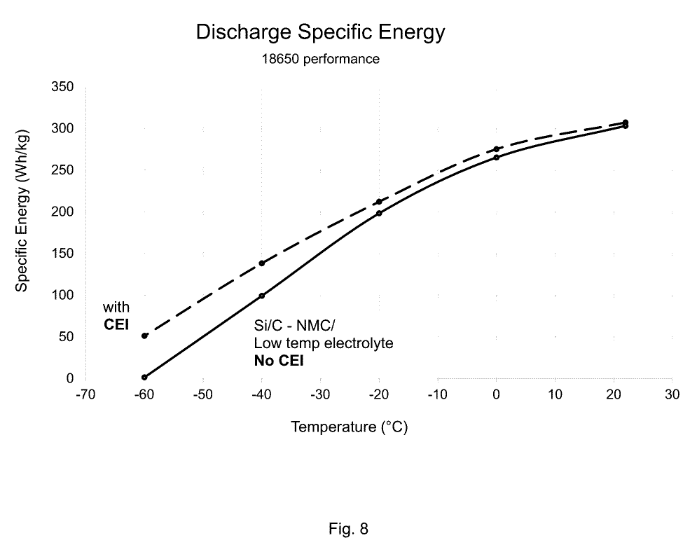

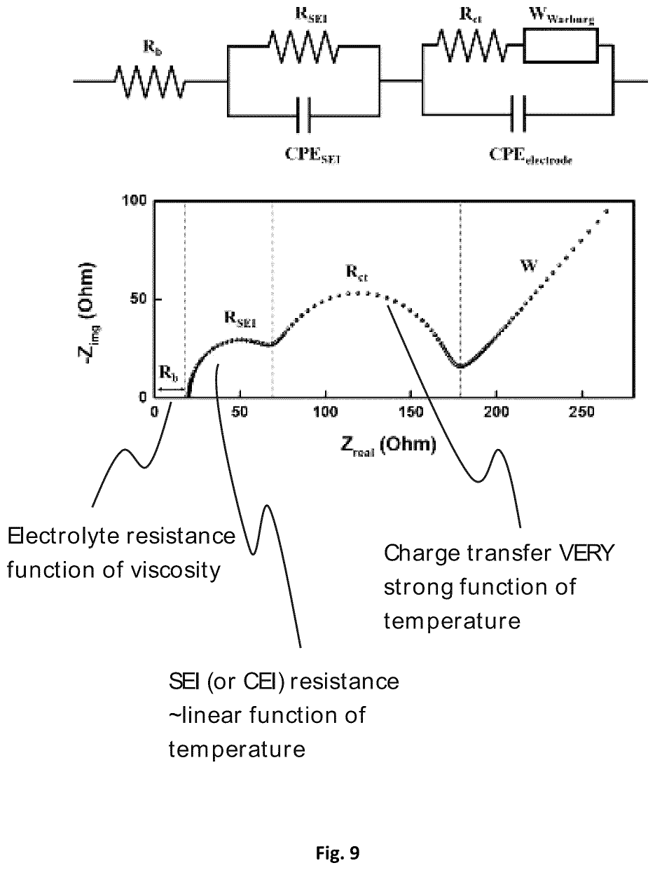

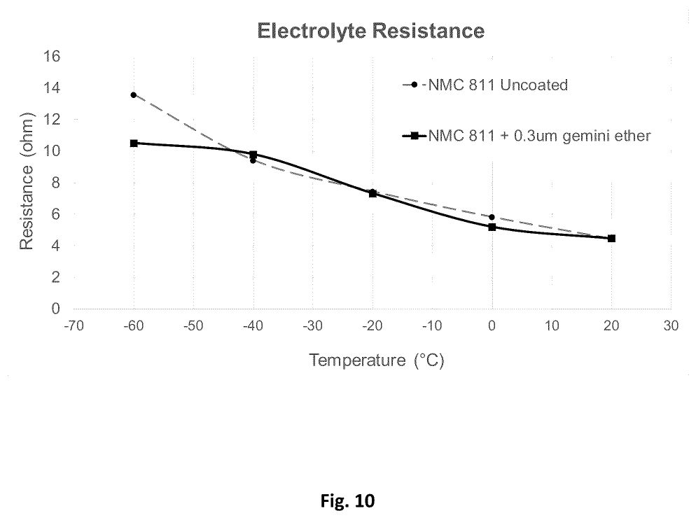

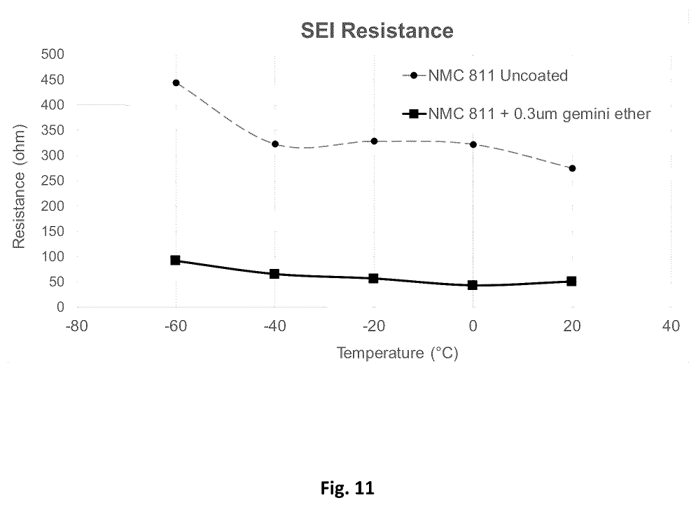

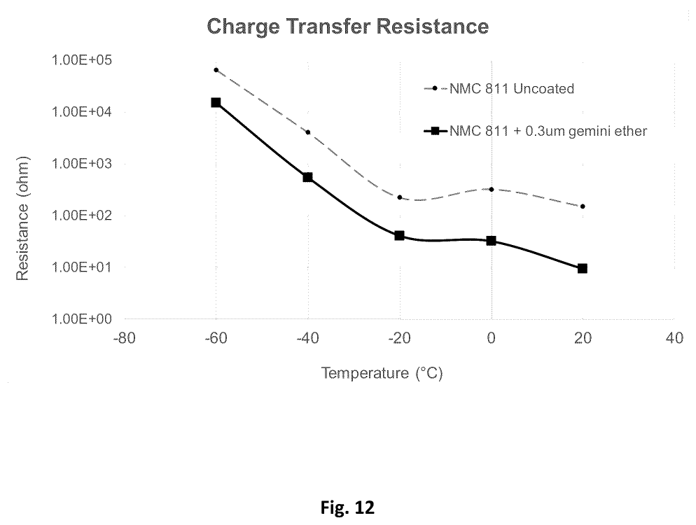

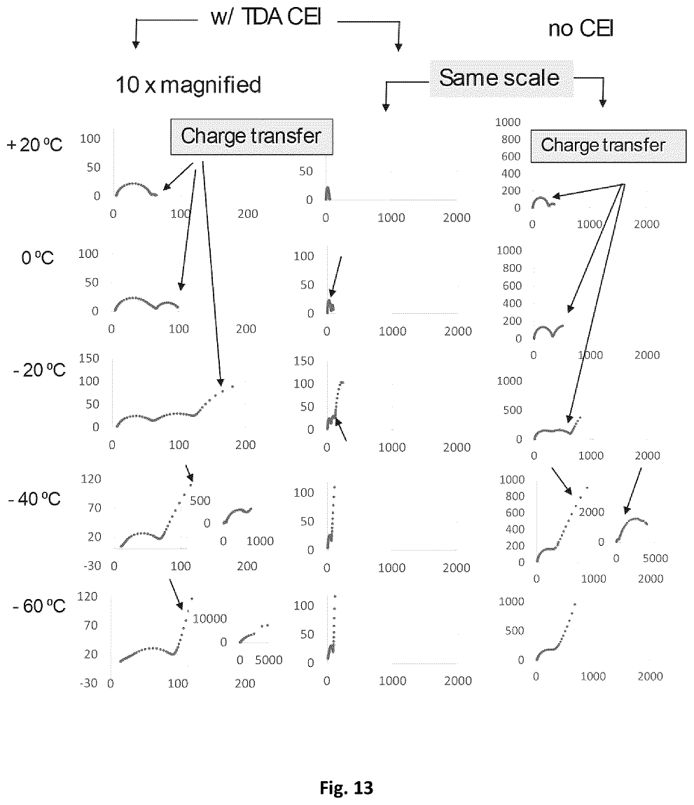

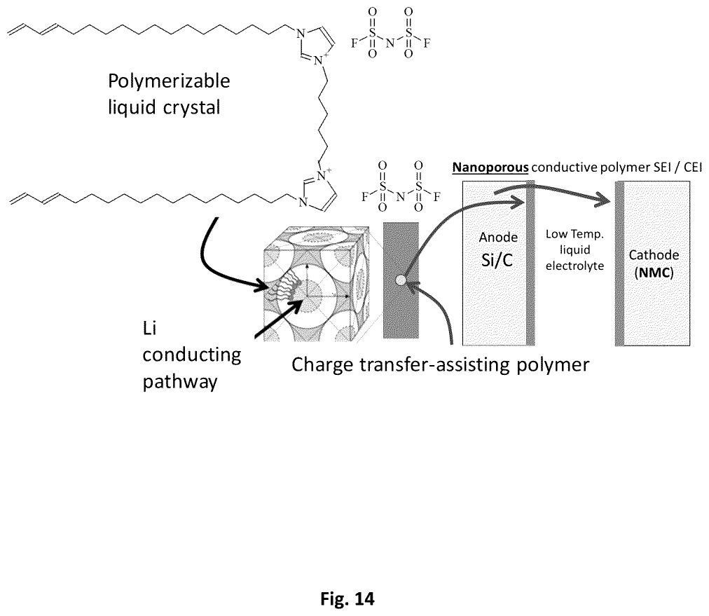

FIG. 7 shows a preferred monomer, and the one that is used for the data presented in FIGS. 8-14. In FIG. 8, the specific energy data are based on C/10 charging at 20° C. and C/10 discharging at the temperature on the x-axis. The battery cells are (20% silicon) Si/C anode, NMC811 cathode, low temperature ester electrolyte (90% methyl propionate 10% fluoroethylene carbonate). The separator is a binder-free borosilicate glass fiber filter, with a thickness of 20 microns. 18650 battery cells in FIG. 7 have a capacity of 4,100 mAhr @ 20° C., and nominal voltage of 3.8 V.

The disclosure provides a low temperature-discharging lithium battery comprising: a Si/C anode; a separator; a nickel metal oxide cathode; a lithium salt; a first solvent, having a low melting point, which is selected from either methyl propionate or butyl propionate; and a second solvent having a high electrochemical stability, which is selected from either fluoroethylene carbonate or ethylene carbonate; and, wherein the first solvent and the second solvent are present at a volume ratio of (first solvent:second solvent) from (1.0:0.01) to (1.0:0.3). Preferably the ratio is 9.0 to 1.0).

The nickel metal oxide cathode has an active material of either NMC811, NMC622, NMC532 a mixed metal nickel-oxide with at least 50 weight % nickel, at least 5 weight % manganese and at least 5 weight % cobalt, or an aluminum-doped mixed metal nickel-oxide with at least 50 weight % nickel and at least 5 weight % aluminum.

The cathode preferably further comprises an electrically conductive carbon and a binder, such as polyvinylidene fluoride. The carbon is used at 1 to 10 weight % and the binder at from 1 to 10 weight %. The cathode may be coated with a charge transfer-assisting polymer coating. This coating forms an artificial CEI or a liquid electrolyte-solid cathode interfacial surface of the nickel metal-oxide cathode.

Preferably, the charge transfer-assisting polymer coating is an ionically conducting polymer, and one that conducts lithium ions. The lithium ion conductivity is preferably above 1×10⁻⁴ S/cm at 20° C.

The charge transfer-assisting polymer coating comprises a lithium ion-conducting polymer that is either an ammonium-containing polymer, and an imidazolium-containing polymer and has at least one polymer segment formed by the polymerization of a latent polymerizable diene.

The monomers have the chemical structure:

R₃-R₂-R₁

where R₃ is a latent polymerizable diene, R₂ is a spacer group and R₁ is a cationic headgroup. The cationic group may be an ammonium and the ammonium functional group has a counter anion, either a bromide, a chloride, an iodide, a PF₆_{^{−}}, a Pf₂N⁻, a BF₄⁻and an FSI⁻ or mixtures thereof. The cationic group may be an imidazolium group. Preferably, the imidazolium ring has a methyl, ethyl or propyl protecting group in the 2-position of the imidazolium ring.

The monomer may optionally comprise the chemical structure:

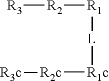

wherein R₃ and R_{3c}, are each a latent polymerizable diene, R₂ and R_{2c}, are spacer groups, which may be the same spacer group or different spacer groups, and R₁ and R_{1c} are each a cationic headgroup. The cationic groups may be an ammonium and the ammonium functional group has a counter anion, either a bromide, a chloride, an iodide, a PF₆_{^{−}}, a Tf₂N⁻, a BF₄_{^{−}} and an FSI⁻or mixtures thereof. The cationic groups may be an imidazolium group. Preferably, the imidazolium ring has a methyl, ethyl or propyl protecting group in the 2-position of the imidazolium ring.

The monomer may also comprise the chemical structure:

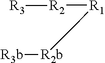

wherein R₃ and R_{3b} are each a latent polymerizable diene, R₂ and R_{2c} are spacer groups, which may be the same spacer group or different spacer group, R₁ and R_{1c} is a cationic headgroup. The cationic groups may be an ammonium and the ammonium functional group has a counter anion, either a bromide, a chloride, an iodide, a PF₆_{^{−}}, a Tf₂N⁻, a BF₄⁻, and an FSI⁻or mixtures thereof. The cationic group may be an imidazolium group. Preferably, the imidazolium ring has a methyl, ethyl or propyl protecting group in the 2-position of the imidazolium ring.

The disclosure also teaches that the polymer coating may be on the Si/CI anode. The charge transfer-assisting polymer coating may coat the liquid electrolyte-solid anode interfacial surface of the Si/C anode, forming an artificial SEI.

Preferably, the charge transfer-assisting polymer coating forming the SEI is an ionically conducting polymer, and one that conducts lithium ions. The lithium ion conductivity is preferably above 1×10⁻⁴ S/cm at 20° C.

The charge transfer-assisting polymer coating comprises a lithium ion-conducting polymer that is either an ammonium-containing polymer, and an imidazolium-containing polymer and has at least one polymer segment formed by the polymerization of a latent polymerizable diene.

The monomers have the chemical structure:

R₃-R₂-R₁

where R₃ is a latent polymerizable diene, R₂ is a spacer group and R₁ is a cationic headgroup. The cationic group may be an ammonium and the ammonium functional group has a counter anion, either a bromide, a chloride, an iodide, a PF₆_{^{−}}, a Tf₂N⁻, a BF₄_{^{−}}and an FSI⁻ or mixtures thereof. The cationic group may be an imidazolium group. Preferably, the imidazolium ring has a methyl, ethyl or propyl protecting group in the 2-position of the imidazolium ring.

The monomer may optionally comprise the chemical structure:

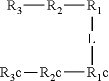

wherein R₃ and R_{3c}, are each a latent polymerizable diene, R₂ and R_{2c} are spacer groups, which may be the same spacer group or different spacer groups, and R₁ and R_{1c} are each a cationic headgroup. The cationic groups may be an ammonium and the ammonium functional group has a counter anion, either a bromide, a chloride, an iodide, a PF₆⁻, a Tf₂N⁻, a BF₄_{^{−}}, and an FSI⁻ or mixtures thereof. The cationic groups may be an imidazolium group. Preferably, the imidazolium ring has a methyl, ethyl or propyl protecting group in the 2-position of the imidazolium ring.

The monomer may also comprise the structure:

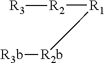

wherein R₃ and R_{3c} are each a latent polymerizable diene, R₂ and R_{2c} are spacer groups, which may be the same spacer group or different spacer group, R₁ and R_{1c} is a cationic headgroup. The cationic groups may be an ammonium and the ammonium functional group has a counter anion, either a bromide, a chloride, an iodide, a PF₆_{^{−}}, a Tf₂N⁻, a BF₄_{^{−}} and an FSI⁻ or mixtures thereof. The cationic group may be an imidazolium group. Preferably, the imidazolium ring has a methyl, ethyl or propyl protecting group in the 2-position of the imidazolium ring.

Synthetic preparation procedures: Bisimidazolium monomers are prepared by independently synthesizing the bisimidazole head group and aliphatic tails, containing polymerizable diene groups. The bisimidazole head group is prepared in one step from imidazole and dibromoalkanes. The C18 diene tail is prepared in four linear, high-yielding steps from pentadecalatone, whereas the C14 tail is prepared in two linear steps from commercially-available 11-bromoundecanol. The final monomer is then assembled from nucleophilic addition reactions between the head group and the tails. By varying the chain lengths of the bisimidazole linkers and the tail lengths, a variety of bisimidazolium monomers can be readily and efficiently accessed.

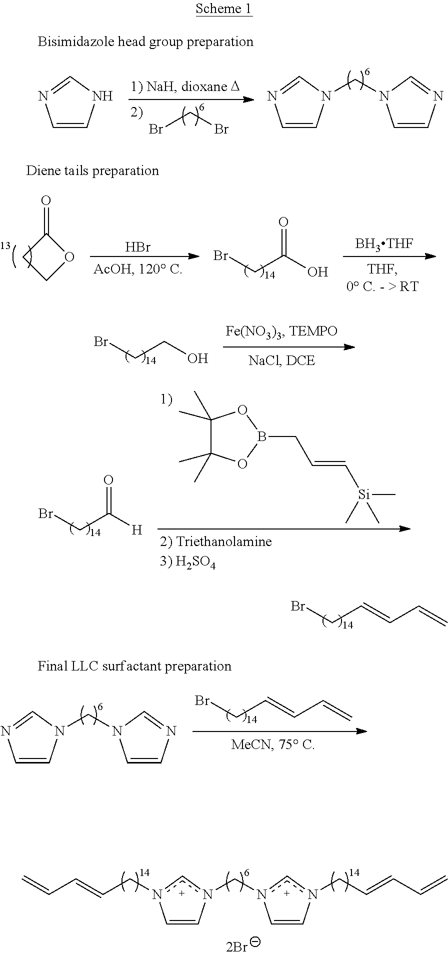

Imidazolium monomers are prepared analogously to the bisimidazolium monomers. The same aliphatic tails, containing polymerizable diene groups are employed; however, the imidazole head groups are typically commercially available materials.

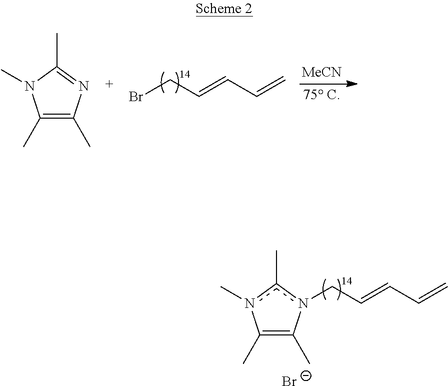

Ammonium Monomers: analogous to their imidazolium-based counterparts, ammonium monomers are prepared by combining amine head groups and aliphatic tails, containing polymerizable diene groups. In many cases, the amines utilized are commercially-available.

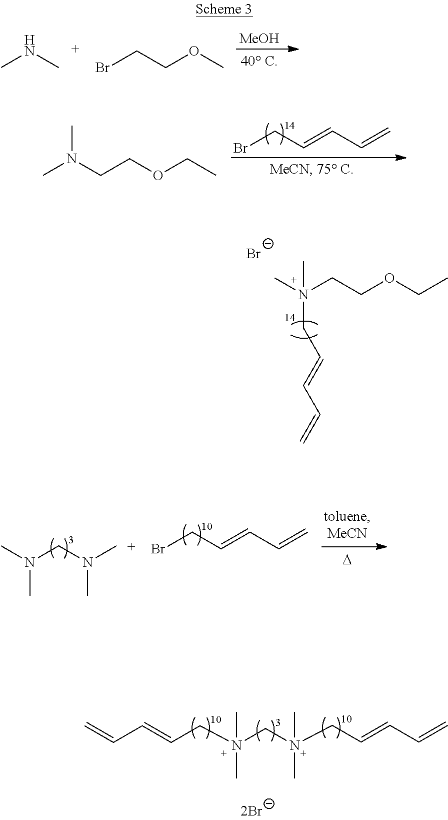

Example 1: Coating the cathode: A solution of a monomer is prepared by taking the monomer, a cosolvent, a radical photopolymerization initiator and combining these into anhydrous methanol at a concentration ranging between 0.5% and 5% by mass. The NMC811 cathode is placed upon a vacuum table heated to 60° C. and vacuum is applied to hold the cathode in place. The cathode is then sprayed with the monomer solution, evaporating the methanol and leaving behind a monomer layer ranging between 0.1 μm-10 μm in thickness. The coated cathode sheet is then moved to another plate where it is sealed from the atmosphere with a rubber gasket and quartz window, heated and the atmosphere is purged with an inert gas (Argon or Nitrogen). The coated cathode is then exposed to ultraviolet light to induce polymerization of the monomer on the cathode surface. The coated cathode is then placed a vacuum oven to dry under vacuum before being transferred to an inert glovebox for coin cell assembly.

Example 2: Coating the anode: A solution of monomer is prepared by taking the monomer, a cosolvent, a radical photopolymerization initiator and combining these into anhydrous tetrahydrofuran at a concentration ranging between 0.5% and 5% by mass. In a glovebox with an atmosphere of <10 ppm H₂O and O₂, the solution is added to a Si/C disk and the tetrahydrofuran evaporates leaving a monomers layer ranging between 0.5-5 mg/cm² loading. The coated Si/C is then placed on a metal plate, sealed with a rubber gasket and a quartz window in an inert Argon atmosphere. The coated lithium is then heated and exposed to ultraviolet light to induce polymerization of the monomer on the Si/C surface. The coated lithium is then transferred back to the inert glovebox for coin cell assembly.

Example 3: Assembly of CR2025 coin cells for EIS studies. CR2025 coin cells are assembled for electrochemical impedance spectroscopy (EIS). In an inert glovebox containing <10 ppm H₂O and O₂, a CR2025 case is fitted with a polypropylene gasket. A 15 mm diameter cathode disk is then placed inside the case, the case is filled with the liquid electrolyte, and a 20 mm diameter Whatman GF/C separator is placed atop the cathode disk. A Si/C disk is placed upon the separator, two stainless steel spacer disks are added atop the Si/C disk, and the coin cell cap is added. The coin cell is then crimped in a hydraulic manual coin cell crimper at a pressure of 5 mPa to seal the cell. Whatman GF/C is a borosilicate fiber nonwoven filter that contains no binders.

Example 4: EIS Conditions. The CR2025 coin cell is then fitted to a potentiostat capable of measuring high frequency electrochemical impedance spectroscopy. The electrochemical impedance is then measured with an AC voltage of 10 mV rms starting at a frequency of 100000 Hz down to 0.1 Hz. The resultant Nyquist data is then fitted to an equivalent circuit to determine the electrolyte, CEI or SEI, and charge transfer resistance.

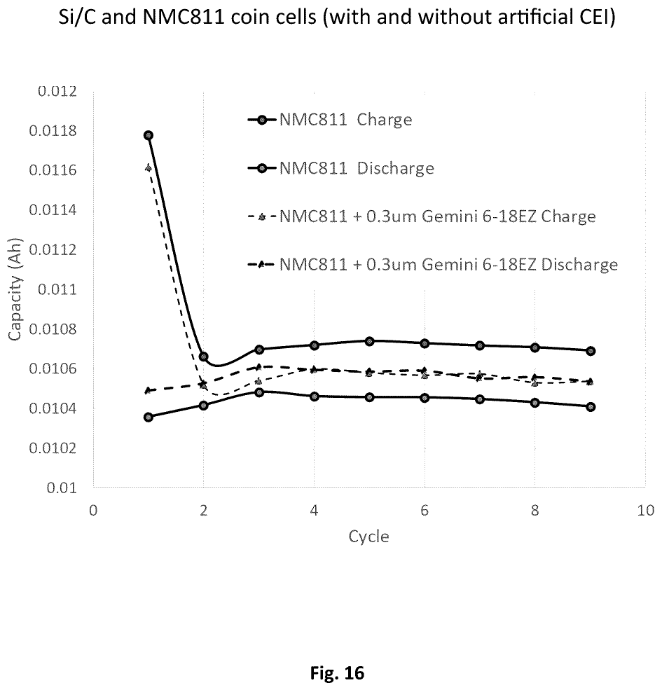

FIG. 16 show how the polymer coating, when used as an artificial CEI on NMC811 (when paired with a Si/C anode and 9:1 MP:FEC electrolyte) can drastically improve the coulombic efficiency (up to 99.9% vs. only 97.0% when no artificial CEI is added).

Addition of flame retardants: the batteries of the present disclosure may contain a liquid electrolyte with from 0.5 to 30 weight % of a flame retarding additive. The electrolyte may contain 1, 2, 3, 4, 5, 6, 7, 8, 9 , 10, 11, 12, 13, 14, 15, 16, 17, 18, 19, or 20 weight % of any of the following flame retardant additives: Dimethyl methylphosphonate (DMMP), Trimethyl phosphate (TMP), Triethyl phosphate (TEP), Triphenyl phosphate (TPP), Tris(2,2,2-trifluoroethyl) phosphate (TFEP or TTFEP), Methyl (2,2,2-trifluoroethyl) carbonate (FEMC), Bis(2,2,2-trifluoroethyl) carbonate (FDEC), Bis(2,2,2-trifluoroethyl) ether (BTFE), 1,1,2,2-tetrafluoroethyl-2,2,3,3-tetrafluoropropyl ether (TTE), Hexafluorocyclotriphosphazene (HFPN), (Ethoxy)pentafluorocyclotriphosphazene (PFPN), (Trifluoroethoxy)pentafluoro-cyclotriphosphazene (TFPN), (Phenoxy)pentafluorocyclotriphosphazene (FPPN).

Although the present invention has been described in considerable detail with reference to certain preferred versions thereof, other versions are possible. Therefore, the spirit and scope of the appended claims should not be limited to the description of the preferred versions contained herein, except where required by 35 U.S.C.§ 112 16 or 35 U.S.C.§ 112 (f).

The reader's attention is directed to all references which are filed concurrently with this specification, and which are incorporated herein by reference.

All the features in this specification (including any accompanying claims, abstract, and drawings) may be replaced by alternative features serving the same, equivalent or similar purpose, unless expressly stated otherwise. Thus, unless expressly stated otherwise, each feature disclosed in one example only of a generic series of equivalent of similar features.

What is claimed is:

1. A low temperature-discharging lithium battery comprising:
a silicon-carbon anode;
a separator;
a nickel metal oxide cathode;
a lithium salt;
a first solvent, having a low melting point, which is selected from either methyl propionate or butyl propionate; and
a second solvent having a high electrochemical stability, which is selected from either fluoroethylene carbonate or ethylene carbonate; and,
wherein the first solvent and the second solvent are present at a volume ratio of (first solvent :
second solvent) from (1.0:0.01) to (1.0:0.3);
wherein the nickel metal oxide cathode comprises an active material consisting of the group selected from NMC811, NMC622, NMC532, a mixed metal nickel-oxide with at least 50 weight % nickel, a mixed metal nickel-oxide with at least 5 weight % manganese and at least 5 weight % cobalt, and an aluminum-doped mixed metal nickel-oxide with at least 50 weight % nickel and at least 5 weight % aluminum; and, wherein, the battery further comprises a charge transfer-assisting polymer coating that coats a liquid electrolyte-solid cathode interfacial surface of the nickel metal-oxide cathode, wherein the charge transfer-assisting polymer coating comprises an ionically conducting polymer, wherein the charge transfer-assisting polymer coating comprises a lithium ion-conducting polymer that is selected from the group consisting of an ammonium-containing polymer, and an imidazolium-containing polymer.

2. The battery of claim 1, wherein the charge transfer-assisting polymer coating comprises a lithium ion-conducting polymer that comprises at least one polymer segment formed by the polymerization of a latent polymerizable diene monomer.

3. The battery of claim 2, wherein the cathode further comprises an electrically conductive carbon and a binder.

4. The battery of claim 3, wherein the binder is polyvinylidene fluoride.

5. The battery of claim 4, wherein the latent polymerizable diene monomer comprises the chemical structure:
R₃-R₂-R₁wherein R₃ is a latent polymerizable diene, R₂ is a spacer group and R₁ is a cationic headgroup.

6. The battery of claim 5, wherein R₁ is a cationic ammonium functional group that further comprises a counter anion selected from the group consisting of a bromide, a chloride, an iodide, a PF₆_{^{−}}, a Tf₂N⁻, a BF₄_{^{−}}, and an FSI⁻.

7. The battery of claim 5, wherein R, comprises an imidazolium functional group that further comprises a counter anion selected from the groups consisting of a bromide, a chloride, an iodide, a PF₆_{^{−}}, a Tf₂N³¹ , a BF₄_{^{−}}, and an FSI⁻.

8. The battery of claim 7, wherein a carbon atom in position 2 of the imidazolium functional group is alkyl substituted with an alkyl pendant moiety selected from the group consisting of a methyl, an ethyl, or a propyl.

9. The battery of claim 5, further comprising the chemical structure: 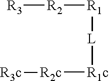
wherein R₃ and R_{3c} are each a latent polymerizable diene, R₂ and R_{2c} are spacer groups, which may be the same spacer group or different spacer groups, R₁ and R_{1c} are each a cationic headgroup, and L is a linker group.

10. The battery of claim 9, wherein R₁ and R_{1c} are each a cationic ammonium functional group that further comprises a counter anion selected from the groups consisting of a bromide, a chloride, an iodide, a PF₆_{^{−}}, a Tf₂N⁻, a BF₄_{^{−}}and an FSI−.

11. The battery of claim 10, wherein R₁ and R_{1c} are each an imidazolium functional group that further comprises a counter anion selected from the groups consisting of a bromide, a chloride, an iodide, a PF₆_{^{−}}, a Tf₂N⁻, a BF₄_{^{−}}and an FSI⁻.

12. The battery of claim 11, wherein a carbon atom in position 2 of the imidazolium functional group is alkyl substituted with an alkyl pendant moiety selected from the group consisting of a methyl, an ethyl or a propyl.

13. The battery of claim 5, further comprising the chemical structure: 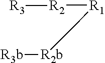
wherein R₃ and R_{3b} are each a latent polymerizable diene, R₂ and R_{2b} are spacer groups, which may be the same spacer group or different spacer groups, and R₁ is a cationic headgroup.

14. The battery of claim 13, wherein R₁ and R_{1b} are each a cationic ammonium functional group that further comprises a counter anion selected from the groups consisting of a bromide, a chloride, an iodide, a PF₆_{^{−}}, a Tf₂N⁻, a BF and an FSI⁻.

15. The battery of claim 14, wherein R₁ and R_{1b} are each an imidazolium functional group that further comprises a counter anion selected from the groups consisting of a bromide, a chloride, an iodide, a PF₆_{^{−}}, a Tf₂N⁻, a BF₄_{^{−}}and an FSI⁻.

16. The battery of claim 15, wherein a carbon atom in position 2 of the imidazolium functional group is alkyl substituted with an alkyl pendent moiety selected from the group consisting of a methyl, an ethyl or a propyl.

17. A low temperature-discharging lithium battery comprising:
a silicon-carbon anode;
a separator;
a nickel metal oxide cathode;
a lithium salt;
a first solvent, having a low melting point, which is selected from either methyl propionate or butyl propionate; and
a second solvent having a high electrochemical stability, which is selected from either fluoroethylene carbonate or ethylene carbonate; and, wherein the first solvent and the second solvent are present at a volume ratio of (first solvent :
second solvent) from (1.0:0.01) to (1.0:0.3);
wherein the nickel metal oxide cathode comprises an active material consisting of the group selected from NMC811, NMC622, NMC532, a mixed metal nickel-oxide with at least 50 weight % nickel, a mixed metal nickel-oxide with at least 5 weight % manganese and at least 5 weight % cobalt, and an aluminum-doped mixed metal nickel-oxide with at least 50 weight % nickel and at least 5 weight % aluminum; and, wherein, the battery further comprises a charge transfer-assisting polymer coating that coats a liquid electrolyte-solid anode interfacial surface of the silicon-carbon anode, wherein the charge transfer-assisting polymer coating comprises an ionically conducting polymer, wherein the charge transfer-assisting polymer coating comprises a lithium ion-conducting polymer that is selected from the group consisting of an ammonium-containing polymer, and an imidazolium-containing polymer.

18. The battery of claim 17, wherein the charge transfer-assisting polymer coating comprises a lithium ion-conducting polymer that comprises at least one polymer segment formed by the polymerization of a latent polymerizable diene monomer.

19. The battery of claim 18, wherein the latent polymerizable diene monomer comprises the chemical structure:
R₃-R₂-R₁ wherein R₃ is a latent polymerizable diene, R₂ is a spacer group and R₁ is a cationic headgroup.

20. The battery of claim 19, wherein R₁ is a cationic ammonium functional group that further comprises a counter anion selected from the group consisting of a bromide, a chloride, an iodide, a PF₆_{^{−}}, a Tf₂N⁻, a BF₆_{^{−}} and an FSI⁻.

21. The battery of claim 19, wherein R₁ comprises an imidazolium functional group that further comprises a counter anion selected from the groups consisting of a bromide, a chloride, an iodide, a PF₆_{^{−}}, a Tf₂N⁻, a BF₄_{^{−}} and an FSI⁻.

22. The battery of claim 21, wherein a carbon atom in position 2 of the imidazolium functional group is alkyl substituted with an alkyl pendant moiety selected from the group consisting of a methyl, an ethyl, or a propyl.

23. The battery of claim 19, further comprising the chemical structure: 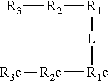
wherein R₃ and R_{3c} are each a latent polymerizable diene, R₂ and R_{2c} are spacer groups, which may be the same spacer group or different spacer groups, R₁ and R_{1c} are each a cationic headgroup, and L is a linker group.

24. The battery of claim 23, wherein R₁ and R_{1c} are each a cationic ammonium functional group that further comprises a counter anion selected from the groups consisting of a bromide, a chloride, an iodide, a PF₆_{^{−}}, a Tf₂N⁻, a BF₄_{^{−}}, and an FSI⁻.

25. The battery of claim 24, wherein R₁ and R_{1c} are each an imidazolium functional group that further comprises a counter anion selected from the groups consisting of a bromide, a chloride, an iodide, a PF₆_{^{−}}, a Tf₂N⁻, a BF₄_{^{−}} and an FSI⁻.

26. The battery of claim 25, wherein a carbon atom in position 2 of the imidazolium functional group is alkyl substituted with an alkyl pendant moiety selected from the group consisting of a methyl, an ethyl or a propyl.

27. The battery of claim 19, further comprising the chemical structure: 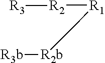
wherein R₃ and R_{3b} are each a latent polymerizable diene, R₂ and R_{2b} are spacer groups, which may be the same spacer group or different spacer groups, and R₁ is a cationic headgroup.

28. The battery of claim 27, wherein R₁ and R_{1b} are each a cationic ammonium functional group that further comprises a counter anion selected from the groups consisting of a bromide, a chloride, an iodide, a PF₆_{^{−}}, a Tf₂N⁻, a BF₄⁻ and an FSI⁻. cm 29. The battery of claim 28, wherein R₁ and R_{1b} are each an imidazolium functional group that further comprises a counter anion selected from the groups consisting of a bromide, a chloride, an iodide, a PF₆_{^{−}}, a Tf₂N⁻, a BF₄_{^{−}} and an FSI⁻.

30. The battery of claim 29, wherein a carbon atom in position 2 of the imidazolium functional group is alkyl substituted with an alkyl pendant moiety selected from the group consisting of a methyl, an ethyl or a propyl.

31. A low-temperature battery electrolyte comprising:
methyl propionate or butyl propionate;
fluoroethyl carbonate;
a lithium salt; and,
a latent polymerizable diene monomer comprises the chemical structure:
R₃-R₂-R₁wherein R₃ is a latent polymerizable diene, R₂ is a spacer group and R₁ is a cationic headgroup.
